(19) United States
(12) Patent Application Publication
(10) Pub. No.: US 2025/0132432 A1
(43) Pub. Date: Apr. 24, 2025

(54) BATTERY MODULE AND METHOD FOR MANUFACTURING THE SAME

(71) Applicant: LG Energy Solution, Ltd., Seoul (KR)

(72) Inventor: Euihoon MYUNG, Daejeon (KR)

(21) Appl. No.: 18/833,839

(22) PCT Filed: Jan. 25, 2023
(86) PCT No.: PCT/KR2023/001137

§ 371 Date: Jul. 26, 2024

(30) Foreign Application Priority Data
Jan. 27, 2022 (KR) 10-2022-0012628

(51) Int. Cl. H01M 50/204; H01M 50/236

(52) U.S. Cl. CPC H01M 50/204; H01M 50/236

(57) ABSTRACT

Provided is a battery module including a battery cell assembly (100) that comprises a reference plate (110) which has a predetermined thickness in a third direction, and a first stack (120) and a second stack (130) which are respectively coupled to a first side surface and a second side surface of the reference plate (110) in the third direction and respectively comprise a plurality of battery cells (C) stacked and coupled to each other in the third direction; and a frame (200) with an inner space (S) in which the battery cell assembly (100) is inserted and accommodated (100). The inner space (S) comprises a predetermined portion (P1) accommodating the reference plate (110), and one side portion (P2) and the other side portion (P3) respectively corresponding to spaces at one side and the other side of the predetermined portion (P1) in the third direction with respect to the predetermined portion (P1) and respectively accommodating the first stack (120) and the second stack (130). A position of the predetermined portion (P1) is determined based on lengths of the first stack (120) and the second stack (130) in the third direction. Thus, the battery module (10) that has a simple configuration and ensures improvement in safety and reliability can be manufactured readily and rapidly without incurring large costs.

### CROSS-REFERENCE TO RELATED APPLICATIONS

This application is a National Phase entry pursuant to 35 U.S.C. § 371 of International Application No. PCT/KR2023/001137, filed on Jan. 25, 2023, and claims priority to and the benefit of Korean Patent Application No. 10-2022-0012628, filed on Jan. 27, 2022, the disclosures of which are incorporated herein by reference in their entirety as if fully set forth herein.

### TECHNICAL FIELD

The present disclosure relates to a battery module and a method for manufacturing the same, and in particular, a battery module and a method for manufacturing the same that has a simple configuration, ensures improvement in safety and reliability and is manufactured readily and rapidly, without incurring large costs.

### BACKGROUND

FIGS. 1 to 3 are a perspective view, an exploded perspective view and a front view showing a battery module of a related art. Referring to FIGS. 1 to 3, the battery module of the related art can comprise a battery cell stack 1 and a frame 2.

The battery cell stack 1 may be comprised of a plurality of battery cells C that is stacked and coupled one on top of another. The battery cell stack 1 can be inserted into the frame 2. The frame 2 may be provided with an inner space S that accommodates the battery cell stack 1. The plurality of battery cells C can be stuck to the inner surface of the frame facing the inner space S by an adhesive resin R that is applied to the inner surface of the frame facing the inner space S.

Based on the technologies of related arts, described above, a battery module can be readily manufactured without incurring large costs. However, each of the stacked battery cells C can be stuck and fixed eccentrically to any one side (e.g., the left side) of the inner space S due to manufacturing tolerance (errors). Accordingly, the cumulative (maximum) tolerance (errors), i.e., D, of the position of an outermost battery cell C, among the stacked battery cells C of the battery cell stack 1, may occur. As D increases, pressure applied between the battery cells C increases when the stacked battery cells C are swollen, causing the burst or explosion of the battery cells C.

Against this backdrop, there is a growing demand for a method of readily manufacturing a battery module that ensures improvement in safety and reliability and does not incur large manufacturing costs.

A related art in relation to this is disclosed in KR Patent Publication No. 10-2021-0007244.

According to the document, a battery cell assembly comprising a plurality of battery cells that is stacked one on top of another, a pair of side plates that is provided at both sides of the battery cell assembly, and a pair of compression pads that is provided at both sides of the pair of side plates, is exposed to both outermost sides of the battery module and absorbs the swelling and assembly tolerance of the battery cell assembly are included.

However, the battery module of the related art is configured in a complex manner and not readily manufactured.

The background description provided herein is for the purpose of generally presenting context of the disclosure. Unless otherwise indicated herein, the materials described in this section are not prior art to the claims in this application and are not admitted to be prior art, or suggestions of the prior art, by inclusion in this section.

### SUMMARY

### Technical Problems

The objective of the present disclosure is to provide a battery module and a method for manufacturing the same that has a simple configuration and is manufactured readily and rapidly without incurring large costs.

The objective of the present disclosure is to provide a battery module and a method for manufacturing the same that ensures improvement in safety and reliability.

Aspects according to the present disclosure are not limited to the above ones, and other aspects and advantages that are not mentioned above can be clearly understood from the following description and can be more clearly understood from the embodiments set forth herein. Additionally, the aspects and advantages in the present disclosure can be realized via means and combinations thereof that are described in the appended claims.

### Technical Solutions

According to the present disclosure, provided is a battery module comprising a battery cell assembly 100 and a frame 200.

The battery cell assembly 100 comprises a reference plate 110, a first stack 120 and a second stack 130.

The reference plate 110 is elongated in a first direction and a second direction across the first direction and has a predetermined thickness in a third direction across the first and second directions.

The first stack 120 is coupled to a first side surface of the reference plate 110 in the third direction and comprises a plurality of battery cells C that are stacked and coupled to each other in the third direction.

The second stack 130 is coupled to a second side surface of the reference plate 110 in the third direction which is opposite to the first side surface and comprises a plurality of battery cells C that are stacked and coupled to each other in the third direction.

The frame 200 is provided with an inner space S in which the battery cell assembly 100 is inserted and accommodated, in a state where the first stack 120 and the second stack 130 are coupled to the reference plate 110, while the battery cell assembly 100 is inserted and accommodated in the inner space S.

The inner space S comprises a predetermined portion P1, one side portion P2 and the other side portion P3.

The reference plate 110 is accommodated in the predetermined portion P1.

The one side portion P2 corresponds to a space at one side of the predetermined portion P1 in the third direction.

The first stack 120 is accommodated in the one side portion P2.

The other side portion P3 corresponds to a space at the other side of the predetermined portion P1 in the third direction.

The second stack 130 is accommodated in the other side portion P3.

A position of the predetermined portion P1 is determined based on lengths of the first stack 120 and the second stack 130 in the third direction.

End portions of both sides of the reference plate 110 in the first direction are coupled to inner surfaces of the frame facing both sides of the predetermined portion P1 in the first direction.

An end portion of one side of at least one of the battery cells C of the first stack 120 in the first direction adheres to an inner surface of the frame facing one side of the one side portion P2 in the first direction.

An end portion of one side of at least one of the battery cells C of the second stack 130 in the first direction adheres to an inner surface of the frame facing one side of the other side portion P3 in the first direction.

In one embodiment, the reference plate 110 may have bend-resistant rigidity in the third direction.

In one embodiment, a guide G may be formed on inner surfaces of the frame facing both sides of the predetermined portion P1 in the first direction and elongated in the second direction.

The end portions of both the sides of the reference plate 110 in the first direction may be inserted into the inner space S in the second direction, along the guide G.

In one embodiment, the predetermined portion P1 may be disposed at a position where a ratio of a width of the one side portion P2 to a width of the other side portion P3 in the third direction corresponds to a ratio of the length of the first stack 120 to the length of the second stack 130 in the third direction.

In one embodiment, the first stack 120 or the second stack 130 may further comprise one or more elastic members E disposed between the battery cells C of the first stack 120 or the second stack 130 and compressed as the battery cell C is swollen.

The one or more of the elastic members E may be respectively disposed between battery cells C that are adjacent to each other in different pairs of battery cells.

In one embodiment, the first stack 120 or the second stack 130 may comprise a plurality of elastic members E.

The plurality of elastic members E may comprise a first elastic member E1 and a second elastic member E2 that is disposed farther from the reference plate 110 than the first elastic member E1 in the third direction.

A thickness of the second elastic member E2 in the third direction may be greater than a thickness of the first elastic member E1 in the third direction.

In one embodiment, the first stack 120 or the second stack 130 may comprise a plurality of elastic members E.

In the third direction, a thickness of each of the elastic members E may be greater than a thickness of another elastic member E that is disposed closer to the reference plate 110 than each of the elastic members E in the third direction.

In one embodiment, the number of battery cells C stacked between elastic members E adjacent to each other and the number of battery cells C stacked between the reference plate 110 and an elastic member E adjacent to the reference plate 110 may be the same.

In one embodiment, the first stack 120 or the second stack 130 may comprise a plurality of elastic members E.

The plurality of elastic members E may comprise a first elastic member E1 and a second elastic member E2 that is disposed farther from the reference plate 110 than the first elastic member E1 in the third direction.

The number of battery cells C stacked between the second elastic member E2, and an elastic member E adjacent to the second elastic member E2 and disposed closer to the reference plate 110 may be less than the number of battery cells C stacked between the first elastic member E1 and a reference plate 110 adjacent to the first elastic member E1 or stacked between the first elastic member E1 and an elastic member E adjacent to the first elastic member E1 and disposed closer to the reference plate 110.

In one embodiment, the first stack 120 or the second stack 130 may comprise a plurality of elastic members E.

The number of battery cells C stacked between one of the elastic members E and an elastic member E adjacent to the one of the elastic members E and disposed closer to the reference plate 110 may be less than the number of battery cells C stacked between another elastic member E that is disposed closer to the reference plate 110 than the one of the elastic members E in the third direction and the reference plate 110 adjacent to the another elastic member E, or stacked between the another elastic member E and an elastic member E adjacent to the another elastic member E and disposed closer to the reference plate 110.

In one embodiment, the plurality of elastic members E may have the same thickness in the third direction.

In one embodiment, in the third direction, a thickness of the one of the elastic members E may be greater than a thickness of the another elastic member E that is disposed closer to the reference plate 110 than the one of the elastic members E in the third direction.

Further, according to the present disclosure, provided is a method for manufacturing the above-described battery module, comprising an insertion step and an adhesion step.

The insertion step comprises inserting the battery cell assembly 100, in the state where the first stack 120 and the second stack 130 are coupled to the reference plate 110, into the inner space S of the frame 200 in the second direction.

At this time, the reference plate 110 is inserted into the predetermined portion P1, the first stack 120 is inserted into one side potion P2, and the second stack 130 is inserted into the other side portion P3.

The adhesion step comprises sticking the end portion of one side of at least one of the battery cells C of the first stack 120 in the first direction to the inner surface of the frame facing one side of the one side portion P2 in the first direction.

Furthermore, the adhesion step comprises sticking the end portion of one side of at least one of the battery cells C of the second stack 130 in the first direction to the inner surface of the frame facing one side of the other side portion P3 in the first direction.

### Advantageous Effects

In the embodiments, a battery module may comprise: a battery cell assembly 100 comprising a reference plate 110 being elongated in a first direction and a second direction across the first direction and having a predetermined thickness in a third direction across the first and second directions, a first stack 120 being coupled to one side surface of the reference plate 110 in the third direction and comprising a plurality of battery cells C that is stacked and coupled one on top of another in the third direction, and a second stack 130 being coupled to the other side surface of the reference plate 110 in the third direction and comprising a plurality of battery cells C that is stacked and coupled one on top of another in the third direction; and a frame 200 being provided with an inner space S in which the battery cell assembly 100 is inserted and accommodated, in a state where the first stack 120 and the second stack 130 are coupled to the reference plate 110, while the battery cell assembly 100 is inserted and accommodated in the inner space S. The inner space S may comprise a predetermined portion P1 accommodating the reference plate 110, one side portion P2 corresponding to a space at one side of the predetermined portion P1 in the third direction with respect to the predetermined portion P1 and accommodating the first stack 120, and the other side portion P3 corresponding to a space at the other side of the predetermined portion P1 in the third direction with respect to the predetermined portion P1 and accommodating the second stack 130. A position of the predetermined portion P1 may be determined based on lengths of the first stack 120 and the second stack 130 in the third direction. End portions of both sides of the reference plate 110 in the first direction may be coupled to inner surfaces of the frame facing both sides of the predetermined portion P1 in the first direction. An end portion of one side of at least one of the battery cells C of the first stack 120 in the first direction may adhere to an inner surface of the frame facing one side of one side portion P2 in the first direction. An end portion of one side of at least one of the battery cells C of the second stack 130 in the first direction may adhere to an inner surface of the frame facing one side of the other side portion P3 in the first direction.

Accordingly, the stacked battery cells C of the battery cell assembly 100 are divided into the battery cells C of the first stack 120 and the battery cells C of the second stack 130 by the reference plate 110, and separately accommodated in one side portion P2 and the other side portion P3 of the inner space S of the frame 200, resulting in a reduction in the number of a series of stacked battery cells C.

For example, in the case where a total number of battery cells C is 12, the number of a series of stacked battery cells C is 12 (FIGS. 1 to 3) in the related art. However, in the present disclosure, the number of a series of stacked battery cells C may be 6 (FIGS. 4 to 6).

Thus, the cumulative (maximum) tolerance (errors) of the position of a battery cell C that is attached and fixed to the inner surface of the frame facing the inner space S of the frame 200 and disposed farthest from the reference plate 110 in the third direction among a series of stacked battery cells C may decrease, even if the stacked battery cells C are fixed to a position eccentric to any one side in the third direction due to manufacturing tolerance (errors), since the battery module 10 is manufactured based on a simple method in which the battery cell assembly 100 is inserted into the inner space S of the frame 200 and the end portion of one side of stacked battery cells C in the first direction adheres to the inner surface of the frame facing one side of the inner space S in the first direction. Thus, in the case where a series of the stacked battery cells C are swollen, pressure applied between the battery cells C may decrease, preventing the burst or explosion of the battery cell C. That is, the battery module 10 that has a simple configuration and ensures improvement in safety and reliability may be manufactured readily and rapidly, without incurring large costs.

For example, while in the related art, the cumulative (maximum) tolerance (errors) of the position of an outermost battery cell C, attached and fixed to the inner surface of the inner space S of the frame 200, among a series of stacked battery cells C, may be D (FIGS. 1 to 3), in the present disclosure, the cumulative (maximum) tolerance (errors) of the position of an outermost battery cell C, attached and fixed to the inner surface of the inner space S of the frame 200, among a series of stacked battery cells C, may decrease to D1 or D2 (FIGS. 4 to 6).

Additionally, since the reference plate 110 is accommodated in the predetermined portion P1 of the inner space S of the frame 200, the battery cell assembly 100 may be readily fixed and disposed in a proper position of the frame 200. In particular, since the battery cell assembly 100 is not eccentrically fixed and disposed toward any one side of the inner space S of the frame 200 in the third direction, the spaces P2, P3 in which the first stack 120 and the second stack 130 are accommodated may have a proper size. Accordingly, even if the battery cells C of the first stack 120 or the battery cells C of the second stack 130 are swollen, the burst or explosion of the battery cells C may be prevented. As a result, the battery module 10 that has a simple configuration and ensures improvement in safety and reliability may be manufactured readily and rapidly, without incurring large costs.

In the embodiments, the reference plate 110 may have bend-resistant rigidity in the third direction.

Thus, even if the first stack 120 or the second stack 130 pressurizes the reference plate 110 in the third direction because of the swelling of battery cells C, the reference plate 110 may not press or may not press firmly the second stack 130 or the first stack 120, which is disposed on the opposite side of the reference plate 110, in the third direction. Therefore, a further increase in the pressure, which is applied between a series of stacked battery cells C of the first stack 120 or the second stack 130 at a time when the stacked battery cells C are swollen, caused by pressure as the stacked battery cells C of the second stack 130 or the first stack 120 on the opposite side of the reference plate 110 are swollen, may be prevented, even if the stacked battery cells C of the first stack 120 or the second stack 130 are fixed to a position eccentric toward the reference plate 110 due to manufacturing tolerance (errors) since the battery module 10 is manufactured based on a simple method in which the battery cell assembly 100 is inserted into the inner space S of the frame 200 and the end portion of one side of stacked battery cells C in the first direction adheres to the inner surface of the frame facing one side of the inner space S in the first direction. Accordingly, the burst or explosion of the battery cell C may be prevented. As a result, the battery module 10 that has a simple configuration and ensures improvement in safety and reliability may be manufactured readily and rapidly without incurring large costs.

In the embodiments, a guide G may be formed on the inner surfaces of the frame facing both sides of the predetermined portion P1 in the first direction, and elongated in the second direction. The end portions of both the sides of the reference plate 110 in the first direction may be inserted into the inner space S in the second direction, along the guide G.

Thus, the battery cell assembly 100 may be readily fixed and installed in a proper position of the frame 200. As a result, the battery module 10 that has a simple configuration and ensures improvement in safety and reliability may be manufactured readily and rapidly, without incurring large costs.

In the embodiments, the predetermined portion P1 may be disposed at a position where a ratio of a width of one side portion P2 to a width of the other side portion P3 in the third direction corresponds to a ratio of the length of the first stack 120 to the length of the second stack 130 in the third direction.

Accordingly, the spaces in which the first stack 120 and the second stack 130 are accommodated may have a proper size, in proportion to the number of the battery cells C of the first stack 120 and the second stack 130, for example. As a result, even if the battery cells C of the first stack 120 or the second stack 130 are swollen, the burst or explosion of the battery cell C may be prevented, ensuring improvement in safety and reliability of the battery module 10.

In the embodiments, the first stack 120 or the second stack 130 may further comprise one or more elastic members E that are disposed between the battery cells C of the first stack 120) or the second stack 130 and are compressed as the battery cell C is swollen. One or more of the elastic members E may be respectively disposed between battery cells C that are adjacent to each other in different pairs of battery cells C.

Accordingly; the elastic members E may absorb or offset the swelling and manufacturing tolerance of the stacked battery cells C of the first stack 120 or the second stack 130, ensuring improvement in the safety and reliability of the battery module 10.

In the embodiments, the first stack 120 or the second stack 130 may comprise a plurality of elastic members E. The plurality of elastic members E may comprise a first elastic member E1 and a second elastic member E2 that is disposed farther from the reference plate 110 than the first elastic member E1 in the third direction. A thickness of the second elastic member E2 in the third direction may be greater than a thickness of the first elastic member E1 in the third direction.

Accordingly, the second elastic member E2, disposed farther from the reference plate 110 than the first elastic member E1 in the third direction, may further absorb or offset the swelling and assembly tolerance of the battery cells C than the first elastic member E1. As a result, the second elastic member E2 absorbs or offsets the cumulative swelling and tolerance of the battery cells C effectively, even if the cumulative swelling and tolerance of the battery cells C disposed farther from the reference plate 110 in the third direction increase, causing an increase in pressure, since a series of battery cells C are stacked in the first stack 120 or the second stack 130, and fixed to the frame 200. Thus, the safety and reliability of the battery module 10 may improve further.

In the embodiments, the first stack 120 or the second stack 130 may comprise a plurality of elastic members E. In the third direction, a thickness of each of the elastic members E may be greater than a thickness of another elastic member E that is disposed closer to the reference plate 110 than each of the elastic members E in the third direction.

Accordingly, as an elastic member E becomes farther from the reference plate 110 in the third direction, the elastic member absorbs or offset the swelling and assembly tolerance of the battery cell C further. As a result, the elastic member E absorbs or offsets the cumulative swelling and tolerance of the battery cells C effectively, even if the cumulative swelling and tolerance of the battery cells C increase, causing an increase in pressure, as the battery cells C become farther from the reference plate 110 in the third direction, since a series of battery cells C are stacked in the first stack 120 or the second stack 130, and fixed to the frame 200. Thus, the safety and reliability of the battery module 10 may improve further.

In the embodiments, the number of battery cells C stacked between elastic members E adjacent to each other and the number of battery cells C stacked between the reference plate 110 and an elastic member E adjacent to the reference plate 110 may all be the same.

Thus, the number of battery cells C disposed at one side or the other side of each elastic member E in the third direction does not need to change depending on the elastic member E, making it possible to readily manufacture the battery cell assembly 100 at low costs.

In the embodiments, the first stack 120 or the second stack 130 may comprise a plurality of elastic members E. The plurality of elastic members E may comprise a first elastic member E1, and a second elastic member E2 that is disposed farther from the reference plate 110 than the first elastic member E1 in the third direction. The number of battery cells C stacked between the second elastic member E2 and the elastic member E which is adjacent to the second elastic member E2 and disposed at the reference plate 110 side may be less than the number of battery cells C stacked between the first elastic member E1 and the reference plate 110 adjacent to the first elastic member E1 or stacked between the first elastic member E1 and the elastic member E which is adjacent to the first elastic member E1 and disposed at the reference plate 110 side.

Accordingly: the swelling and assembly tolerance of a battery cells C disposed farther from the reference plate 110 in the third direction may be absorbed or offset further. As a result, the second elastic member E2 absorbs or offsets the cumulative swelling and tolerance of the battery cells C effectively, even if the cumulative swelling and tolerance of the battery cells C disposed farther from the reference plate 110 in the third direction increase, causing an increase in pressure, since a series of battery cells C are stacked in the first stack 120 or the second stack 130, and fixed to the frame 200. Thus, the safety and reliability of the battery module 10 may improve further.

In the embodiments, the first stack 120 or the second stack 130 may comprise a plurality of elastic members E. At this time, the number of battery cells C staked between each elastic member E and the elastic member E which is adjacent to each elastic member E and disposed at the reference plate 110 side may be less than the number of battery cells C stacked between another elastic member E which is disposed closer to the reference plate 110 than each elastic member E in the third direction, and the reference plate 110 which is adjacent to another elastic member E, or stacked between another elastic member E and the elastic member E which is adjacent to another elastic member E and disposed at the reference plate 110 side.

Accordingly, the swelling and assembly tolerance of a battery cell C disposed farther from the reference plate 110 in the third direction may be absorbed or offset further. As a result, the elastic members E absorb or offset the cumulative swelling and tolerance of the battery cells C effectively, even if the cumulative swelling and tolerance of the battery cells C increase, causing an increase in pressure, as the battery cells C become farther from the reference plate 110 in the third direction, since a series of battery cells C are stacked in the first stack 120 or the second stack 130, and fixed to the frame 200. Thus, the safety and reliability of the battery module 10 may improve further.

In the embodiments, the thickness of the plurality of elastic members E in the third direction may all be the same.

Thus, the thickness of the elastic member E in the third direction does not need to change depending on the position of the elastic member E, making it possible to readily manufacture the battery cell assembly 100 at low costs.

In the embodiments, in the third direction, the thickness of each of the elastic members E may be greater than the thickness of another elastic member E that is disposed closer to the reference plate 110 than each of the elastic members E in the third direction.

Thus, as the elastic member E becomes farther from the reference plate 110 in the third direction, the swelling and assembly tolerance of the battery cell C may be absorbed or offset more effectively. As a result, the elastic member E absorbs or offsets the cumulative swelling and tolerance of the battery cells C more effectively, even if the cumulative swelling and tolerance of the battery cells C increase, causing an increase in pressure, as the battery cells C become farther from the reference plate 110 in the third direction, since a series of battery cells C are stacked in the first stack 120 or the second stack 130, and fixed to the frame 200, such that. Thus, the safety and reliability of the battery module 10 may improve further.

In the embodiments, a method for manufacturing a battery module may comprise: an insertion step of inserting the battery cell assembly 100, in the state where the first stack 120 and the second stack 130 are coupled to the reference plate 110, into the inner space S of the frame 200 in the second direction, inserting the reference plate 110 into the predetermined portion P1, inserting the first stack 120 into one side potion P2, and inserting the second stack 130 into the other side portion P3; and an adhesion step of sticking an end portion of one side of at least one of the battery cells C of the first stack 120 in the first direction to the inner surface of the frame facing one side of one side portion P2 in the first direction, and sticking an end portion of one side of at least one of the battery cells C of the second stack 130 in the first direction to the inner surface of the frame facing one side of the other side portion P3 in the first direction.

Accordingly, the stacked battery cells C of the battery cell assembly 100 are divided into stacked battery cells C of the first stack 120 and stacked battery cells C of the second stack 130, by the reference plate 110, and separately accommodated in one side portion P2 and the other side portion P3 of the inner space S of the frame 200, resulting in a reduction in the number of a series of sacked battery cells C.

Thus, the cumulative (maximum) tolerance (errors) of the position of a battery cell C, attached and fixed to the inner surface of the inner space S of the frame 200 and disposed farthest from the reference plate 110 in the third direction among a series of the stacked battery cells C, may decrease, even if a series of stacked battery cells C are eccentrically fixed to any one side in the third direction because of manufacturing tolerance (errors), since the battery module 10 is manufactured based on a simple method in which the battery cell assembly 100 is inserted into the inner space S of the frame 200 and the end portion of one side of stacked battery cells C in the first direction adheres to the inner surface of the frame facing one side of the inner space S in the first direction. Thus, in the case where a series of the stacked battery cells C are swollen, pressure applied between the battery cells C may decrease, preventing the burst or explosion of the battery cells C. Thus, the battery module 10 that has a simple configuration and ensures improvement in safety and reliability may be manufactured readily and rapidly without incurring large costs.

Additionally, since the reference plate 110 is accommodated in the predetermined portion P1 of the inner space S of the frame 200, the battery cell assembly 100 may be readily fixed and installed in a proper position of the frame 200. In particular, since the battery cell assembly 100 is not fixed and installed eccentrically toward any one side of the inner space S of the frame 200 in the third direction, the spaces P2, P3 in which the first stack 120 and the second stack 130 are accommodated may have a proper size. Thus, the burst or explosion of the battery cells C may be prevented even if the battery cells C of the first stack 120 or the second stack 130 are swollen, and the battery module 10 that has a simple configuration and ensures improvement in safety and reliability may be manufactured readily and rapidly, without incurring large costs.

Specific effects are described along with the above-described effects in the section of detailed description

### BRIEF DESCRIPTION OF DRAWINGS

FIGS. 1 to 3 are a perspective view, an exploded perspective view, and a front view showing a battery module of the related art.

FIGS. 4 to 6 are a perspective view, an exploded perspective view, and a front view showing a battery module of one embodiment.

FIGS. 7 to 9 are front views showing a battery module of other embodiments.

FIG. 10 is a flowchart showing a method for manufacturing a battery module of one embodiment.

| | |
|---|---|
| 10: Battery module | |
| 100: Battery cell assembly | C: Battery cell |
| 110: Reference plate | 120: First stack |
| 130: Second stack | E: Elastic member |
| E1: First elastic member | E2: Second elastic member |
| 200: Frame | S: Inner space |
| P1: Predetermined portion | P2: One side portion |
| P3: The other side portion | G: Guide |
| R: Adhesive resin | |

### DETAILED DESCRIPTION OF EXEMPLARY EMBODIMENTS

The above-described aspects, features and advantages are specifically described hereafter with reference to the accompanying drawings such that one having ordinary skill in the art to which the present disclosure pertains can embody the technical spirit of the disclosure easily. In the disclosure, detailed description of known technologies in relation to the subject matter of disclosure is omitted if it is deemed to make the gist of the disclosure unnecessarily vague. Hereafter, preferred embodiments according to the disclosure are specifically described with reference to the accompanying drawings. In the drawings, identical reference numerals can denote identical or similar components.

The terms “first”, “second” and the like are used herein only to distinguish one component from another component. Thus, the components should not be limited by the terms. Certainly, a first component can be a second component, unless stated to the contrary.

Throughout the disclosure, each component can be provided as a single one or a plurality of ones, unless explicitly stated to the contrary.

When any one component is described as being “in the upper portion (or lower potion)” or “on (or under)” another component, any one component can be directly on (or under) another component, but an additional component can be interposed between any one component and another component on (or under) any one component.

When any one component is described as being “connected”, “coupled”, or “connected” to another component, any one component can be directly connected or coupled to another component, but an additional component can be “interposed” between the two components or the two components can be “connected”, “coupled”, or “connected” by an additional component.

The singular forms “a”, “an” and “the” are intended to include the plural forms as well, unless explicitly indicated otherwise. It is to be understood that the terms “comprise” or “include” and the like, set forth herein, are not interpreted as necessarily including all the stated components or steps but can be interpreted as excluding some of the stated components or steps or can be interpreted as including additional components or steps.

### [Battery Module]

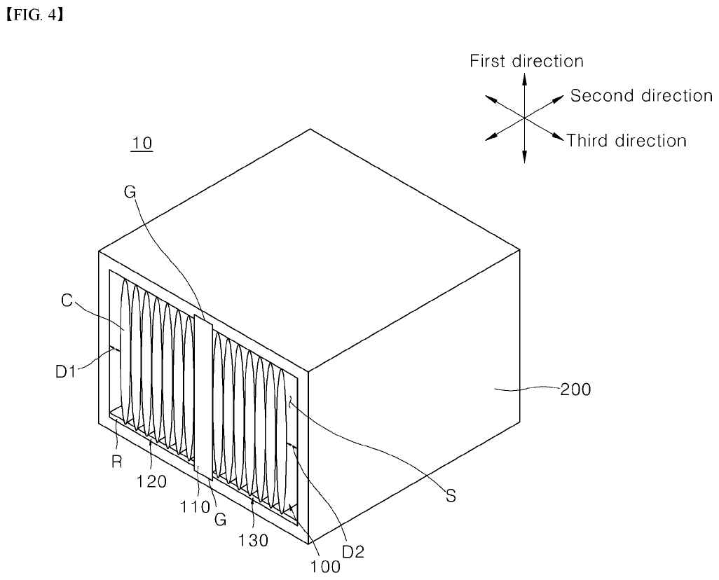

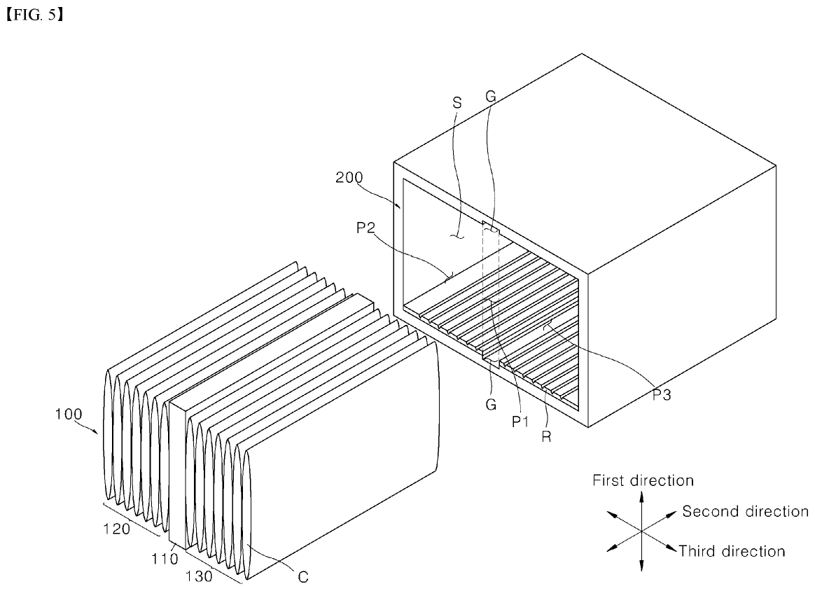

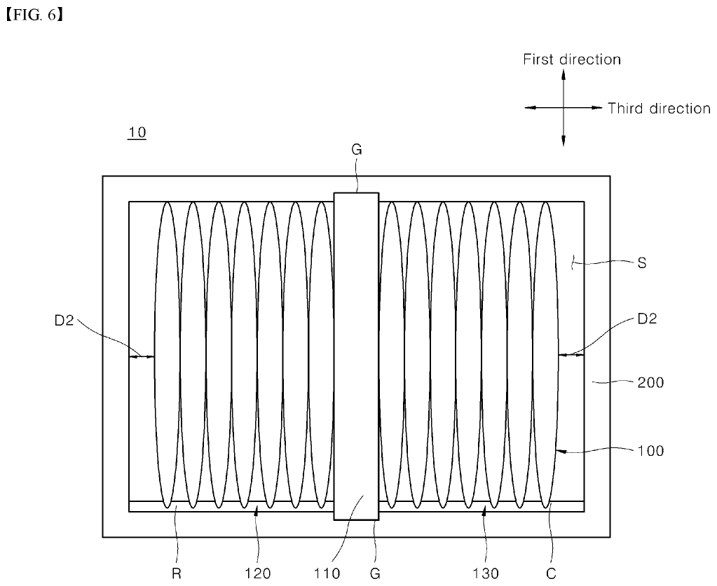

FIGS. 4 to 6 are a perspective view; an exploded perspective view; and a front view showing a battery module of one embodiment.

Referring to FIGS. 4 to 6, a battery module 10 of one embodiment may comprise a battery cell assembly 100, and a frame 200.

### [Battery Cell Assembly]

The battery cell assembly 100 may comprise a reference plate 110, a first stack 120 and a second stack 130.

The battery cell assembly 100 may be accommodated in the inner space S of the frame 200. For example, the battery cell assembly 100 may be inserted into the inner space S of the frame 200 in a second direction (e.g., the front-rear direction).

The reference plate 110 may be elongated in a first direction (e.g., the up-down direction) and the second direction (e.g., the front-rear direction) across the first direction. The reference plate 110 may have a predetermined thickness in a third direction (e.g., the left-right direction) across the first direction and the second direction. The reference plate 110 is formed into a plate.

The reference plate 110 may be accommodated in a predetermined portion P1 of the inner space S of the frame 200. Both end portions of the reference plate 110 in the first direction may be coupled to both inner surfaces of the predetermined portion P1 in the first direction.

The reference plate 110 may have bend-resistant rigidity in the third direction. For example, the reference plate 110 may be made of a metallic material.

Thus, even if the first stack 120 or the second stack 130 pressurizes the reference plate 110 in the third direction because of the swelling of battery cells C, the reference plate 110 may not press or may not press firmly the second stack 130 or the first stack 120, which is disposed on the opposite side of the reference plate 110, in the third direction. Therefore, a further increase in the pressure, which is applied between a series of stacked battery cells C of the first stack 120 or the second stack 130 at a time when the stacked battery cells C are swollen, caused by pressure as the stacked battery cells C of the second stack 130 or the first stack 120 on the opposite side of the reference plate 110 are swollen, may be prevented, even if the stacked battery cells C of the first stack 120 or the second stack 130 are fixed to a position eccentric toward the reference plate 110 due to manufacturing tolerance (errors) since the battery module 10 is manufactured based on a simple method in which the battery cell assembly 100 is inserted into the inner space S of the frame 200 and the end portion of one side of stacked battery cells C in the first direction adheres to the inner surface of the frame facing one side of the inner space S in the first direction. Accordingly, the burst or explosion of the battery cell C may be prevented. As a result, the battery module 10 that has a simple configuration and ensures improvement in safety and reliability may be manufactured readily and rapidly without incurring large costs.

The first stack 120 may be coupled to one side surface (e.g., the left surface) of the reference plate 110 in the third direction. The first stack 120 may comprise a plurality of battery cells C that are stacked and coupled one on top of another in the third direction.

For example, among the plurality of battery cells C of the first stack 120, the other side surface (e.g., the right surface) of a battery cell C in the third direction disposed at the other side end (e.g., the right side end) of the first stack 120 in the third direction may be coupled to one side surface of the reference plate 110 in the third direction. Additionally, one side surface or the other side surface of each battery cell C of the first stack 120 in the third direction may be coupled to the other side surface or one side surface of an adjacent battery cell C of the first stack 120 in the third direction.

The first stack 120 may be accommodated in one side portion P2 (e.g., the left portion) of the inner space S of the frame 200. Herein, one side portion P2 may correspond to a space at one side of the predetermined portion P1, in the third direction, with respect to the predetermined portion P1 in the inner space S of the frame 200.

The end portion of one side (e.g., the lower side) of at least one battery cell C of the first stack 120, in the first direction, may adhere to the inner surface of the frame facing one side of one side portion P2 in the first direction.

For example, the end portions of the lower sides of all the battery cells C of the first stack 120 may adhere to the inner surface of the frame facing the lower side of one side portion P2.

The second stack 130 may be coupled to the other side surface (e.g., the right surface) of the reference plate 110 in the third direction. The second stack 130 may comprise a plurality of battery cells C that are stacked and coupled one on top of another in the third direction.

For example, among the plurality of battery cells C of the second stack 130, one side surface (e.g., the left surface) of a battery cell C in the third direction disposed at one side end (e.g., the left side end) of the second stack 130 in the third direction may be coupled to the other side surface of the reference plate 110 in the third direction. Additionally, one side surface or the other side surface of each battery cell C of the second stack 130 in the third direction may be coupled to the other side surface or one side surface of an adjacent battery cell C of the second stack 130 in the third direction.

The second stack 130 may be accommodated in the other side portion P3 (e.g., the right portion) of the inner space S of the frame 200. Herein, the other side portion P3 may correspond to a space at the other side of the predetermined portion P1, in the third direction, with respect to the predetermined portion P1 in the inner space S of the frame 200.

The end portion of one side of at least one battery cell C of the second stack 130, in the first direction, may adhere to the inner surface of the frame facing one side of the other side portion P3 in the first direction.

For example, the end portions of the lower sides of all the battery cells C of the second stack 130 may adhere to the inner surface of the frame facing the lower side of the other side portion P3.

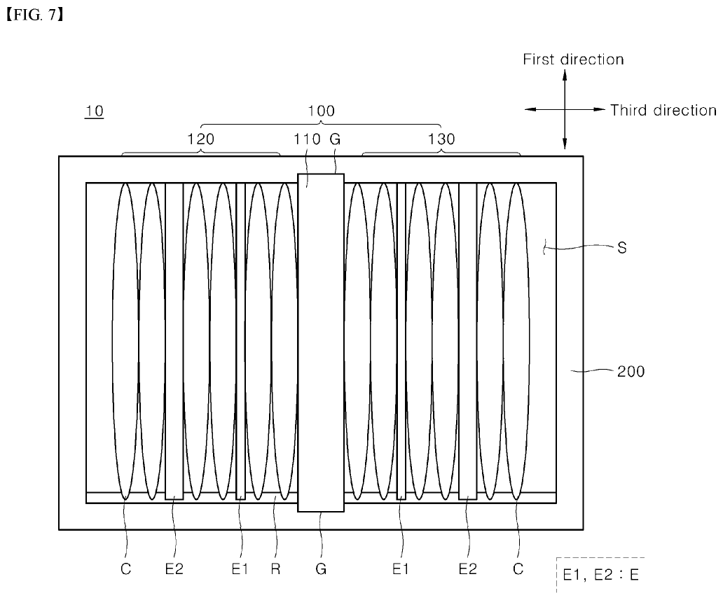

Additionally, the first stack 120 or the second stack 130 may further comprise an elastic member E. The elastic member E is described with reference to FIGS. 7 to 9, hereafter.

### [Frame]

The frame 200 may have an inner space S. A battery cell assembly 100 may be accommodated in the inner space S.

The inner space S may comprise a predetermined portion P1, one side portion P2, and the other side portion P3.

A reference plate 110 may be accommodated in the predetermined portion P1. The position of the predetermined portion P1 may be determined based on the lengths of a first stack 120 and a second stack 130 in the third direction. Both inner surfaces of the frame facing the predetermined portion P1 in the first direction may be coupled to both end portions of the reference plate 110 in the first direction.

One side portion P2 may correspond to a space at one side of the predetermined portion P1 in the third direction, with respect to the predetermined portion P2. The first stack 120 may be accommodated in one side portion P2.

The other side portion P3 may correspond to a space at the other side of the predetermined portion P1 in the third direction, with respect to the predetermined portion P1. The second stack 130 may be accommodated in the other side portion P3.

The end portion of one side of at least one battery cell C of the first stack 120 and the second stack 130 in the first direction may respectively adhere to the inner surface of the frame facing one side of one side portion P2 and the other side portion P3 in the first direction. For example, an adhesive resin R may be applied to the inner surface of the frame facing one side of one side portion P2 and the other side portion P3 in the first direction, and the end portion of one side of at least one battery cell C of the first stack 120 and the second stack 130 in the first direction may respectively adhere to the adhesive resin R applied to the inner surface of the frame facing one side of one side portion P2 and the other side portion P3 in the first direction.

As described above, the stacked battery cells C of the battery cell assembly 100 are divided into the stacked battery cells C of the first stack 120 and the stacked battery ells C of the second stack 130 by the reference plate 110, and the stacked battery cells C of the first stack 120 and the stacked battery ells C of the second stack 130 are separately accommodated in one side portion P2 and the other side portion P3 of the inner space S of the frame 200. Accordingly, the number of a series of stacked battery cells C may decrease.

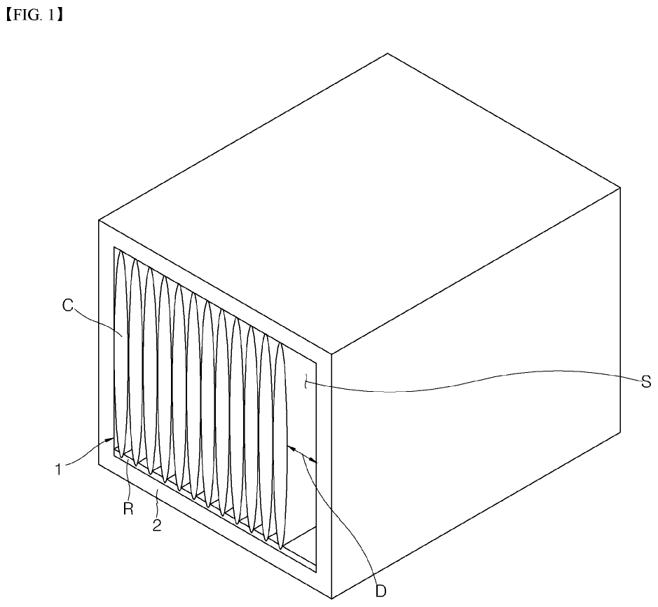

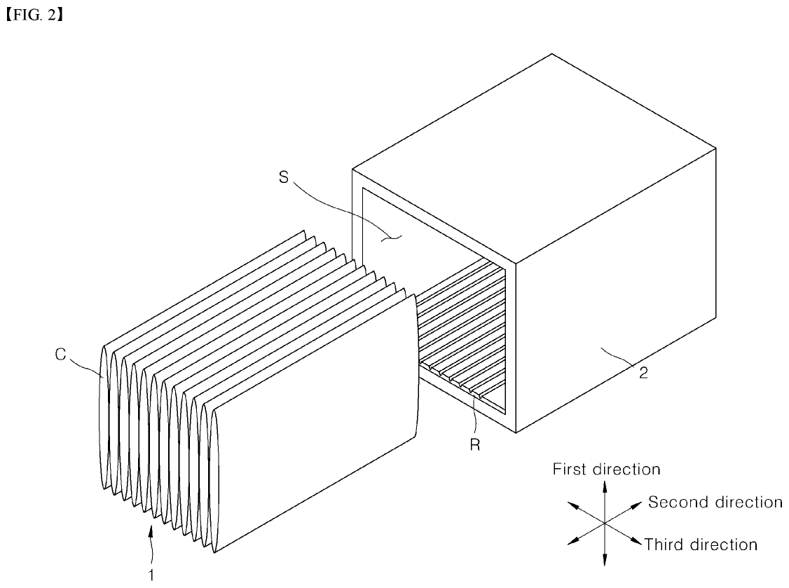

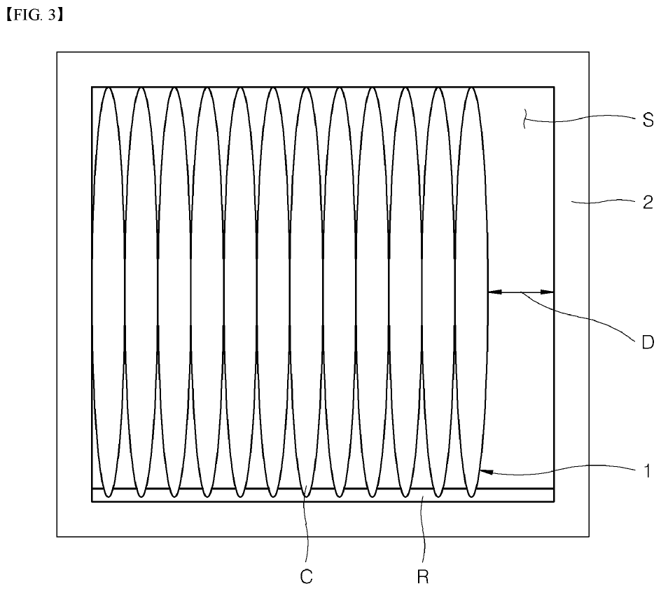

For example, in the case where a total number of battery cells C is 12, the number of a series of stacked battery cells C is 12 (FIGS. 1 to 3) in the related art. However, in the present disclosure, the number of a series of stacked battery cells C may be 6 (FIGS. 4 to 6).

Thus, the cumulative (maximum) tolerance (errors) of the position of a battery cell C that is attached and fixed to the inner surface of the inner space S of the frame 200 and disposed farthest from the reference plate 110 in the third direction among a series of stacked battery cells C may decrease, even if the stacked battery cells C are fixed to a position eccentric to any one side in the third direction due to manufacturing tolerance (errors), since the battery module 10 is manufactured based on a simple method in which the battery cell assembly 100 is inserted into the inner space S of the frame 200 and the end portion of one side of stacked battery cells C in the first direction adheres to the inner surface of the frame facing one side of the inner space S in the first direction. Thus, in the case where a series of the stacked battery cells C are swollen, pressure applied between the battery cells C may decrease, preventing the burst or explosion of the battery cell C. That is, the battery module 10 that has a simple configuration and ensures improvement in safety and reliability may be manufactured readily and rapidly, without incurring large costs.

For example, while in the related art, the cumulative (maximum) tolerance (errors) of the position of an outermost battery cell C, attached and fixed to the inner surface of the inner space S of the frame 200, among a series of stacked battery cells C, may be D (FIGS. 1 to 3), in the present disclosure, the cumulative (maximum) tolerance (errors) of the position of an outermost battery cell C, attached and fixed to the inner surface of the inner space S of the frame 200, among a series of stacked battery cells C, may decrease to D1 or D2 (FIGS. 4 to 6).

Additionally, since the reference plate 110 is accommodated in the predetermined portion P1 in the inner space S of the frame 200, the battery cell assembly 100 may be readily fixed and disposed in a proper position of the frame 200. In particular, since the battery cell assembly 100 is not eccentrically fixed and disposed toward any one side of the inner space S of the frame 200 in the third direction, the spaces P2, P3 in which the first stack 120 and the second stack 130 are accommodated may have a proper size. Accordingly, even if the battery cells C of the first stack 120 or the battery cells C of the second stack 130 are swollen, the burst or explosion of the battery cells C may be prevented. As a result, the battery module 10 that has a simple configuration and ensures improvement in safety and reliability may be manufactured readily and rapidly, without incurring large costs.

A guide G may be formed on the inner surfaces of the frame facing both sides of the predetermined portion P1 in the first direction, and elongated in the second direction. The guide G may be a guide groove that is elongated in the second direction, for example, but not limited.

The ends portions of both sides of the reference plate 110 in the first direction may be inserted into the inner space S in the second direction, along the guide G.

Accordingly; the battery cell assembly 100 may be readily fixed and installed in a proper position of the frame 200. Thus, the battery module 10 that has a simple configuration and ensures improvement in safety and reliability may be manufactured readily and rapidly, without incurring large costs.

The predetermined portion P1 may be disposed in a position where a ratio of the width of one side portion P2 to the width of the other side portion P3 in the third direction corresponds to a ratio of the length of the first stack 120 to the length of the second stack 130 in the third direction.

Accordingly, the spaces where the first stack 120 and the second stack 130 are accommodated may have a proper size, in proportion to the number of the battery cells C of the first stack 120 and the second stack 130, for example. Thus, even if the battery cells C of the first stack 120 or the second stack 130 are swollen, the burst or explosion of the battery cells C may be prevented, ensuring improvement in the stability and reliability of the battery module 10.

### [Elastic Member]

FIGS. 7 to 9 are front views showing a battery module of other embodiments. A difference between the battery module of one embodiment and the battery module of other embodiments is described.

As described above, the first stack 120 or the second stack 130 may further comprise one or more elastic members E.

One or more elastic members E may be disposed among the battery cells C of the first stack 120 or the second stack 130. Each of the elastic members E may be compressed (e.g., in the third direction) as the battery cells C are swollen. Each elastic member E may absorb a pressurizing force caused by the swelling of the battery cells C. Each elastic member E may be made of a porous material or a foamed synthetic resin.

One or more of the elastic members E may be disposed between battery cells C of the first stack 120 or the second stack 130, which are adjacent to each other in different pairs of battery cells (FIGS. 7 to 9).

Accordingly, the elastic member E may absorb or offset the swelling and assembly tolerance of the stacked battery cells C of the first stack 120 or the second stack 130, ensuring improvement in the safety and reliability of the battery module 10.

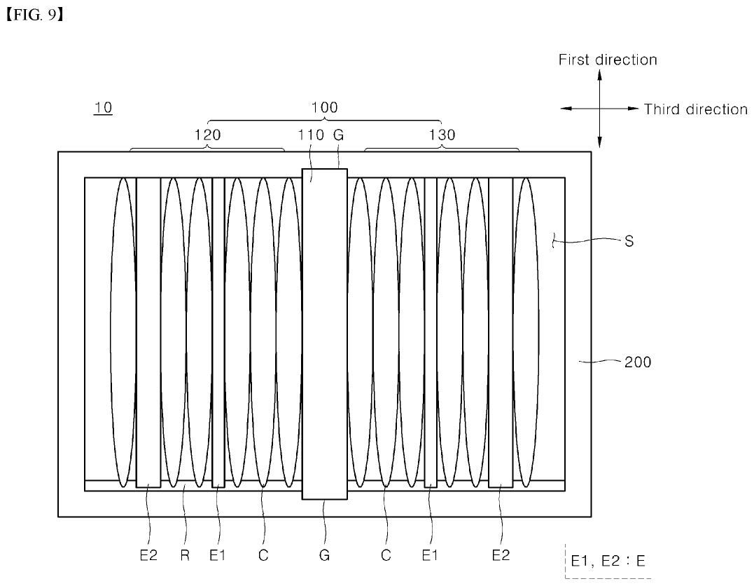

The first stack 120 or the second stack 130 may comprise a plurality of elastic members E. At this time, the plurality of elastic members E may comprise a first elastic member E1, and a second elastic member E2 that is disposed farther from the reference plate 110 than the first elastic member E1 in the third direction. The thickness of the second elastic member E2 in the third direction may be greater than the thickness of the first elastic member E1 in the third direction (FIGS. 7 and 9).

Accordingly, the second elastic member E2, disposed farther from the reference plate 110 than the first elastic member E1 in the third direction, may further absorb or offset the swelling and assembly tolerance of the battery cells C than the first elastic member E1. As a result, the second elastic member E2 absorbs or offsets the cumulative swelling and tolerance of the battery cells C effectively even if the cumulative swelling and tolerance of the battery cells C disposed farther from the reference plate 110 in the third direction increase, causing an increase in pressure, since a series of battery cells C are stacked in the first stack 120 or the second stack 130, and fixed to the frame 200. Thus, the safety and reliability of the battery module 10 may improve further.

As described above, the first stack 120 or the second stack 130 may comprise a plurality of elastic members E. At this time, in the third direction, the thickness of each elastic member E may be greater than the thickness of another elastic member E that is disposed closer to the reference plate 110 than each elastic member E in the third direction (FIGS. 7 and 9).

Accordingly, as an elastic member E becomes farther from the reference plate 110 in the third direction, the elastic member absorbs or offset the swelling and assembly tolerance of the battery cell C further. As a result, the elastic member E absorbs or offsets the cumulative swelling and tolerance of the battery cells C effectively, even if the cumulative swelling and tolerance of the battery cells C increase, causing an increase in pressure, as the battery cells C become farther from the reference plate 110 in the third direction, since a series of battery cells C are stacked in the first stack 120 or the second stack 130, and fixed to the frame 200, such that. Thus, the safety and reliability of the battery module 10 may improve further.

At this time, the number of battery cells C staked between mutually adjacent elastic members E may and the number of battery cells C stacked between the reference plate 110 and an elastic member E that is adjacent to the reference plate 110 may all be the same.

For example, as illustrated in FIG. 7, the number of battery cells C stacked between the first elastic member E1 and the second elastic member E2 which are adjacent to each other may be 2 that is the same as the number of battery cells C stacked between the reference plate 110 and the first elastic member E1 which is adjacent to the reference plate 110.

Thus, the number of battery cells C disposed at one side or the other side of each elastic member E in the third direction does not need to change depending on the elastic member E, making it possible to readily manufacture the battery cell assembly 100 at low costs.

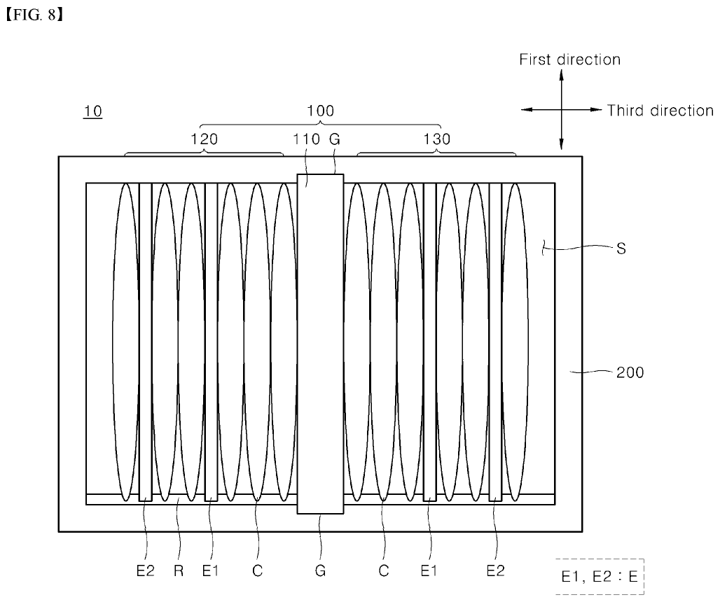

As described above, the first stack 120 or the second stack 130 may comprise a plurality of elastic members E. and the plurality of elastic members E may comprise a first elastic member E1, and a second elastic member E2 that is disposed farther from the reference plate 110 than the first elastic member E1 in the third direction. At this time, the number of battery cells C stacked between the second elastic member E2 and the elastic member E which is adjacent to the second elastic member E2 and disposed at the reference plate 110 side may be less than the number of battery cells C stacked between the first elastic member E1 and the reference plate 110 adjacent to the first elastic member E1 or stacked between the first elastic member E1 and the elastic member E which is adjacent to the first elastic member E1 and disposed at the reference plate 110 side (FIGS. 8 and 9).

For example, as illustrated in FIGS. 8 and 9, the number of battery cells C stacked between the second elastic member E2 and the first elastic member E1 which is adjacent to the second elastic member E2 and disposed at the reference plate 110 side is 2 that is less than three battery cells C stacked between the first elastic member E1 and the reference plate 110 which is adjacent to the first elastic member E1.

Accordingly; the swelling and assembly tolerance of a battery cells C disposed farther from the reference plate 110 in the third direction may be absorbed or offset further. As a result, the second elastic member E2 absorbs or offsets the cumulative swelling and tolerance of the battery cells C effectively even if the cumulative swelling and tolerance of the battery cells C disposed farther from the reference plate 110 in the third direction increase, causing an increase in pressure, since a series of battery cells C are stacked in the first stack 120 or the second stack 130, and fixed to the frame 200. Thus, the safety and reliability of the battery module 10 may improve further.

As described above, the first stack 120 and the second stack 130 may comprise a plurality of elastic members E. At this time, the number of battery cells C staked between each elastic member E and the elastic member E which is adjacent to each elastic member E and disposed at the reference plate 110 side may be less than the number of battery cells C stacked between another elastic member E which is disposed closer to the reference plate 110 than each elastic member E in the third direction and the reference plate 110 which is adjacent to another elastic member E or stacked between another elastic member E and the elastic member E which is adjacent to another elastic member E and disposed at the reference plate 110 side (FIGS. 8 and 9).

For example, as illustrated in FIGS. 8 and 9, the number of battery cells C stacked between the second elastic member E2 and the first elastic member E1 which is adjacent to the second elastic member E2 and disposed at the reference plate 110 side is 2 that is less than 3 battery cells C stacked between the first elastic member E1 which is disposed closer to the reference plate 110 than the second elastic member E2 in the third direction and the reference plate 110 which is adjacent to the first elastic member E1.

Accordingly, the swelling and assembly tolerance of a battery cell C disposed farther from the reference plate 110 in the third direction may be absorbed or offset further. As a result, the elastic member E absorbs or offsets the cumulative swelling and tolerance of the battery cells C effectively, even if the cumulative swelling and tolerance of the battery cells C increase, causing an increase in pressure, as the battery cells C become farther from the reference plate 110 in the third direction, since a series of battery cells C are stacked in the first stack 120 or the second stack 130, and fixed to the frame 200. Thus, the safety and reliability of the battery module 10 may improve further.

At this time, the thickness of the plurality of elastic members E in the third direction may all be the same (FIG. 8).

Thus, the thickness of the elastic member E in the third direction does not need to change depending on the position of the elastic member E, making it possible to readily manufacture the battery cell assembly 100 at low costs.

Unlike the thickness of the elastic member E mentioned above, in the third direction, the thickness of each elastic member E may be greater than the thickness of another elastic member E disposed closer to the reference plate 110 than each elastic member E in the third direction (FIG. 9).

For example, as illustrated in FIG. 9, in the third direction, the thickness of the second elastic member E2 may be greater than the thickness of the first elastic member E1 that is disposed closer to the reference plate 110 than the second elastic member E2 in the third direction.

Thus, as the elastic member E becomes farther from the reference plate 110 in the third direction, the swelling and assembly tolerance of the battery cell C may be absorbed or offset more effectively. As a result, the elastic member E absorbs or offsets the cumulative swelling and tolerance of the battery cells C effectively, even if the cumulative swelling and tolerance of the battery cells C increase, causing an increase in pressure, as the battery cells C become farther from the reference plate 110 in the third direction, since a series of battery cells C are stacked in the first stack 120 or the second stack 130, and fixed to the frame 200. Thus, the safety and reliability of the battery module 10 may improve further.

### [Method of Manufacturing Battery Module]

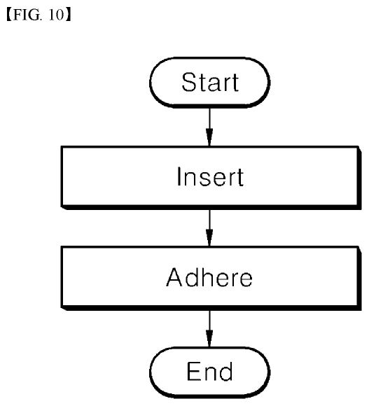

FIG. 10 is a flowchart showing a method of manufacturing a battery module of one embodiment.

Referring to FIG. 10, the method for manufacturing a battery module of one embodiment may comprise an insertion step and an adhesion step.

In the insertion step, while a battery cell assembly 100, in the state where a first stack 120 and a second stack 130 are coupled to a reference plate 110, is inserted into the inner space S of a frame 200 in the second direction, the reference plate 110 may be inserted into a predetermined portion P1, the first stack 120 may be inserted into one side potion P2, and the second stack 130 may be inserted into the other side portion P3.

At this time, the end portions of both sides of the reference plate 110 in the first direction may be inserted into the inner space S in the second direction, along a guide G.

In the adhesion step, the end portion of one side of at least one battery cell C of the first stack 120 in the first direction may contact the inner surface of the frame facing one side of one side portion P2 in the first direction, and the end portion of one side of at least one battery cell C of the second stack 130 in the first direction may contact the inner surface of the frame facing one side of the other side portion P3 in the first direction.

Accordingly, the stacked battery cells C of the battery cell assembly 100 are divided into stacked battery cells C of the first stack 120 and stacked battery cells C of the second stack 130, by the reference plate 110, and separately accommodated in one side portion P2 and the other side portion P3 of the inner space S of the frame 200, resulting in a reduction in the number of a series of sacked battery cells C.

Thus, the cumulative (maximum) tolerance (errors) of the position of a battery cell C, attached and fixed to the inner surface of the inner space S of the frame 200 and disposed farthest from the reference plate 110 in the third direction among a series of the stacked battery cells C, may decrease, even if a series of stacked battery cells C are eccentrically fixed to any one side in the third direction because of manufacturing tolerance (errors), since the battery module 10 is manufactured based on a simple method in which the battery cell assembly 100 is inserted into the inner space S of the frame 200 and the end portion of one side of stacked battery cells C in the first direction adheres to the inner surface of the frame facing one side of the inner space S in the first direction. Thus, in the case where a series of the stacked battery cells C are swollen, pressure applied between the battery cells C may decrease, preventing the burst or explosion of the battery cells C. Thus, the battery module 10 that has a simple configuration and ensures improvement in safety and reliability may be manufactured readily and rapidly without incurring large costs.

Additionally, since the reference plate 110 is accommodated in the predetermined portion P1 of the inner space S of the frame 200, the battery cell assembly 100 may be readily fixed and installed in a proper position of the frame 200. In particular, since the battery cell assembly 100 is not fixed and installed eccentrically toward any one side of the inner space S of the frame 200 in the third direction, the spaces P2, P3 in which the first stack 120 and the second stack 130 are accommodated may have a proper size. Thus, the burst or explosion of the battery cells C may be prevented even if the battery cells C of the first stack 120 or the second stack 130 are swollen, and the battery module 10 that has a simple configuration and ensures improvement in safety and reliability may be manufactured readily and rapidly, without incurring large costs.

The embodiments described above are provided as examples and are not provided in a limited manner, in all aspects. Further, the meaning and scope of the disclosure are defined according to the claims described hereafter rather than the particulars of the detailed description, and all modifications and changes drawn from the meaning and scope of the claims and the equivalents thereof are to be construed as being included in the scope of the disclosure.

The embodiments are described above with reference to a number of illustrative embodiments thereof. However, embodiments are not limited to the embodiments and drawings set forth herein, and numerous other modifications and embodiments can be drawn by one skilled in the art within the technical scope of the disclosure. Further, the effects and predictable effects based on the configurations in the disclosure are to be included within the scope of the disclosure though not explicitly described in the description of the embodiments.

1. A battery module, comprising:
a battery cell assembly comprising:
a reference plate being elongated in a first direction and a second direction across the first direction and having a predetermined thickness in a third direction across the first and second directions,
a first stack being coupled to a first side surface of the reference plate in the third direction and comprising a plurality of battery cells that are stacked and coupled to each other in the third direction, and
a second stack being coupled to a second side surface of the reference plate in the third direction which is opposite to the first side surface and comprising a plurality of battery cells that are stacked and coupled to each other in the third direction; and
a frame being provided with an inner space in which the battery cell assembly is inserted and accommodated, in a state where the first stack and the second stack are coupled to the reference plate, while the battery cell assembly is inserted and accommodated in the inner space,
wherein the inner space comprises a predetermined portion (P1) accommodating the reference plate, one side portion (P2) corresponding to a space at one side of the predetermined portion (P1) in the third direction and accommodating the first stack, and the other side portion (P3) corresponding to a space at the other side of the predetermined portion (P1) in the third direction and accommodating the second stack,
wherein a position of the predetermined portion (P1) is determined based on lengths of the first stack and the second stack in the third direction,
wherein end portions of both sides of the reference plate in the first direction are coupled to inner surfaces of the frame facing both sides of the predetermined portion (P1) in the first direction,
wherein an end portion of one side of at least one of the battery cells of the first stack in the first direction adheres to an inner surface of the frame facing one side of the one side portion (P2) in the first direction, and
wherein an end portion of one side of at least one of the battery cells of the second stack in the first direction adheres to an inner surface of the frame facing one side of the other side portion (P3) in the first direction.

2. The battery module of claim 1, where the reference plate has bend-resistant rigidity in the third direction.

3. The battery module of claim 1, wherein a guide (G) is formed on inner surfaces of the frame facing both sides of the predetermined portion (P1) in the first direction and elongated in the second direction, and
wherein the end portions of both the sides of the reference plate in the first direction are inserted into the inner space in the second direction, along the guide (G).

4. The battery module of claim 1, wherein the predetermined portion (P1) is disposed at a position where a ratio of a width of the one side portion (P2) to a width of the other side portion (P3) in the third direction corresponds to a ratio of the length of the first stack to the length of the second stack in the third direction.

5. The battery module of claim 1, wherein the first stack or the second stack further comprises one or more elastic members that are disposed between the battery cells of the first stack or the second stack and are compressed as the battery cell is swollen, and
wherein the one or more of the elastic members are respectively disposed between battery cells that are adjacent to each other in different pairs of battery cells.

6. The battery module of claim 5, wherein the first stack or the second stack comprises a plurality of elastic members,
wherein the plurality of elastic members comprises a first elastic member and a second elastic member that is disposed farther from the reference plate than the first elastic member in the third direction, and
wherein a thickness of the second elastic member in the third direction is greater than a thickness of the first elastic member in the third direction.

7. The battery module of claim 5, wherein the first stack or the second stack comprises a plurality of elastic members, and
wherein in the third direction, a thickness of each of the elastic members is greater than a thickness of another elastic member that is disposed closer to the reference plate than each of the elastic members in the third direction.

8. The battery module of claim 7, wherein the number of battery cells stacked between elastic members adjacent to each other and the number of battery cells stacked between the reference plate and an elastic member adjacent to the reference plate are all the same.

9. The battery module of claim 5, wherein the first stack or the second stack comprises a plurality of elastic members,
wherein the plurality of elastic members comprises a first elastic member and a second elastic member that is disposed farther from the reference plate than the first elastic member in the third direction, and
wherein the number of battery cells stacked between the second elastic member, and an elastic member adjacent to the second elastic member and disposed closer to the reference plate is less than the number of battery cells stacked between the first elastic member and the reference plate or stacked between the first elastic member, and an elastic member (E) adjacent to the first elastic member (E1) and disposed closer to the reference plate.

10. The battery module of claim 5, wherein the first stack or the second stack comprises a plurality of elastic members, and
wherein the number of battery cells stacked between one of the elastic members, and an elastic member adjacent to the one of the elastic members and disposed closer to the reference plate is less than the number of battery cells stacked between another elastic member that is disposed closer to the reference plate than the one of the elastic members in the third direction, and the reference plate adjacent to the another elastic member or stacked between the another elastic member, and an elastic member adjacent to the another elastic member and disposed closer to the reference plate.

11. The battery module of claim 10, wherein the plurality of elastic members all have the same thickness in the third direction.

12. The battery module of claim 10, wherein in the third direction, a thickness of the one of the elastic members is greater than a thickness of the another elastic member that is disposed closer to the reference plate than the one of the elastic members in the third direction.

13. A method for manufacturing a battery module of claim 1, comprising:
an insertion step of inserting the battery cell assembly, in the state where the first stack and the second stack are coupled to the reference plate, into the inner space of the frame in the second direction, inserting the reference plate into the predetermined portion (P1), inserting the first stack into one side potion (P2), and inserting the second stack into the other side portion (P3); and
an adhesion step of sticking the end portion of one side of at least one of the battery cells of the first stack in the first direction to the inner surface of the frame facing one side of the one side portion (P2) in the first direction, and sticking the end portion of one side of at least one of the battery cells of the second stack in the first direction to the inner surface of the frame facing one side of the other side portion (P3) in the first direction.
